(19) United States
(12) Patent Application Publication
(10) Pub. No.: US 2023/0151189 A1
(43) Pub. Date: May 18, 2023

(54) RUBBER COMPOSITION FOR TYRE BODY COMPOUNDS

(71) Applicant: APOLLO TYRES GLOBAL R&D B.V., Enschede (NL)

(72) Inventors: Vikram SINGH, Enschede (NL); Anup MONDAL, Enschede (NL); Tharik MOHAMED, Enschede (NL); Louis REUVEKAMP, Enschede (NL)

(21) Appl. No.: 17/915,855

(22) PCT Filed: Mar. 26, 2021
(86) PCT No.: PCT/EP2021/057978

§ 371 Date: Sep. 29, 2022

(30) Foreign Application Priority Data
Mar. 30, 2020 (LU) LU101720

(51) Int. Cl. C08L 7/00; C08L 9/00; C08K 3/04; C08K 3/36; B60C 1/00

(52) U.S. Cl. CPC C08L 7/00; C08L 9/00; C08K 3/04; C08K 3/36; B60C 1/0016; B60C 1/0025; C08L 2205/035; C08L 2205/025; C08L 2312/00; B60C 2001/0066

(57) ABSTRACT

The present invention relates to a cross-linkable rubber composition for body compounds of a tyre, the cross-linkable rubber composition comprising, based upon parts by weight per 100 parts by weight rubber (phr): ≥30 to ≤90 phr of a natural rubber or isoprene rubber or combination thereof, ≥10 to ≤25 phr of a syndiotactic 1, 2-polybutadiene, ≥3 to ≤10 phr of a resin, and a filler, wherein the ratio in phr (parts by weight per 100 parts by weight of rubber) of the syndiotactic 1, 2-polybutadiene to the resin is in the range of ≥1:1 to ≤7:1.

The present invention relates to a cross-linkable rubber composition, a cross-linked rubber composition obtained by cross-linking such a rubber composition, a method of preparing a tyre and a tyre comprising body compounds.

As is known, there is a strong demand within the tyre industry for compounds from which to produce tyre components of low hysteresis and, therefore, improved rolling resistance, but without compromising other characteristics, such as stiffness, affecting handling performance of the tyre.

Individual tyre component characteristics are commonly tailored on the basis of the type and amount of processing oils, tackifiers and homogenizer resins employed in the respective compounds.

As anyone skilled in the art knows, processing oils, tackifiers and homogenizer resins assist for improving processing characteristics, and they are also known to increase hysteresis and, therefore, rolling resistance.

To obtain a compound capable of achieving both good rolling resistance and good handling performance, a common practice is to add processing oils, tackifiers and homogenizer resins to get better properties. Though neither of these solutions impairs hysteresis or stiffness, neither do they bring about any significant improvement.

EP2607099B1 relates to a pneumatic tire having a cap/base configuration comprising an outer tread cap rubber layer, with a tread running surface, and an underlying tread base rubber layer, where the base rubber layer contains syndiotactic polybutadiene with a diverse blend of carbon blacks.

DE102014212489A1 discloses a sulfur-crosslinkable rubber mixture for the sidewall of vehicle tires, which has cold flow properties, at the same time the other properties, in particular abrasion resistance and/or tear properties and/or heat buildup or the rolling resistance behavior, are not adversely affected.

JP2016060789A provides a rubber composition for bead filler and a rubber composition for run-flat supporting material each of which comprises a diene rubber component with a glass transition point of 0° C. or less, and a polymer having a syndiotactic-1,2-polybutadiene chain.

Accordingly, it is desired to improve the hardness and hysteresis of the rubber compound with comparable or similar mechanical properties as to the conventional compounds.

This object is achieved by a cross-linkable rubber composition according to claim 1, a cross-linked rubber composition according to claim 9, a method according to claim 13, a tyre comprising body compounds according to claim 14, and a body compound according to claim 15. Advantageous embodiments are the subject of dependent claims. They may be combined freely unless the context clearly indicates otherwise.

Surprisingly, the inventors have found out that using syndiotactic 1,2-polybutadiene and a coumarene indene resin in a certain ratio improves hardness and hysteresis of the rubber compound. This is even more surprising as it can eliminate the use of processing oils, tackifiers and homogenizer resins in the rubber composition for similar processing characteristics.

Accordingly, it is provided a cross-linkable rubber composition for body compounds of a tyre, the cross-linkable rubber composition comprising, based upon parts by weight per 100 parts by weight rubber (phr): ≥30 to ≤90 phr of a natural rubber or isoprene rubber or combination thereof, ≥10 to ≤25 phr of a syndiotactic 1,2-polybutadiene, ≥3 to 10 phr of a resin, and a filler, wherein the ratio in phr (parts by weight per 100 parts by weight of rubber) of the syndiotactic 1, 2-polybutadiene to the resin is in the range of ≥1:1 to ≤7:1.

The natural rubber may be a sheet processed natural rubber such as a Ribbed Smoked Sheets (RSS) rubber or may be a Technically Specified Rubber (TSR). There exist different grades of Ribbed Smoked Sheets rubber, usually grades RSS-2, RSS-3 and RSS— 4 are used for tyre treads. TSR grades such as TSR10, TSR20 are also used in tyre tread compounds.

In the context of this invention the unit “phr” denotes “per hundred parts by weight of rubber”, as it is commonly understood in the art. It is further understood that in formulations discussed in connection with the present invention the phr amount of all rubber components adds up to 100.

In the context of this invention the term “syndiotactic-1,2-polybutadiene” refers to a polybutadiene with a 1,2-butadiene microstructure that has at least 90 percent, preferably 90 to 95 percent, more preferably 94 percent, of its repeating units in a 1,2-configuration, namely a syndiotactic 1,2-configuration, and further preferably has a syndiotactic 1,2-crystallinity in a range of 25% to 40%, preferably 36%. Furthermore, the melting point of the syndiotactic-1,2-polybutadiene may be in a range of 100° C.-130° C., preferably 126° C. Further, the elongation at break may be between 300% to 350%, preferably 330%. In embodiments, the syndiotactic 1,2 polybutadiene contains at least 90 percent of its repeating units in a 1,2-configuration. An example for the syndiotactic 1,2 polybutadiene is a commercial product denoted “AT 400” available from JSR.

According to one embodiment, the resin is selected from the class of hydrocarbon thermoplastic resins with melting point above −25° C. such as terpene based resins, alpha methyl styrene, styrene functionalized resins, coumarone indene based resins, C5 resins, C9 resins, modified resins or a combination thereof.

According to an preferred embodiment the resin is a coumarone indene C10 resin.

According to an embodiment, the filler is selected from silica, carbon black or combination thereof. Examples for carbon blacks are N134, N220, N330, N339, N379, also 2109, 2115, 2123, 2125 from Birla carbon. Examples for silica are Zeosil-1085MP, 1115MP, 1165MP, HRS 1200MP; Premium 200MP from Rhodia; Ultrasil-5000GR, 7000GR, 9100GR from Evonik Industries; Hi-sil-EZ120G(G-D), EZ160G (G-D), 190G (G-D), EZ200G (G-D), 210, 255CG-D, 315G (G-D) from PPG Industries. Examples for surface treated silica are Agilon 400, Agilon 454, Agilon 458 from PPG Industries. Examples for surface treated carbon blacks are 2125XZ from Birla Carbon.

According to a preferred embodiment the filler is present in an amount of ≥30 phr to ≤60 phr.

According to a preferred embodiment the composition further comprises a second rubber selected from butadiene rubber, styrene butadiene rubber, solution polymerized styrene butadiene rubber or combination thereof. The second rubber may be selected from polybutadiene, functionalized polybutadiene rubber, emulsion-styrene butadiene rubber (ESBR), solution-styrene butadiene rubber (SSBR), functionalized SSBR, or a combination thereof. A functionalized elastomer (polybutadiene rubber or SSBR) is a chemically modified elastomer: whose chain ends are modified either on one end or both ends with same or different functional groups; or modified along the chain or combination thereof; such as carboxyl groups, amine groups, hydroxyl groups; moreover chemical modification is also possible along the elastomer chain. Functionalized elastomers may have combination of chain end functionalization with functionalization along the chain. Examples of the second rubber are HPR850, HPR950, HPR840, HPR940, BR740, BR511 from JSR Corporation; SLR4602, SLR6402, SLR3402 from Styron; F3430, N211, S202, L251 from Asahi Kasei.

According to a preferred embodiment the second rubber is present in an amount of ≥15 phr to ≤60 phr.

According to a preferred embodiment the composition is free from plasticizing oil, tackifier resin, homogenizing resin or a combination thereof.

The cross-linkable rubber composition according to the invention comprises cross-linkable groups in the rubber component(s). They may be cross-linked (cured, vulcanised) by methods known to a skilled person in the rubber technology field. The cross-linkable rubber compositions may be sulfur-vulcanizable and/or peroxide-vulcanizable. Other vulcanization systems may also be used. If desired, additives can be added. Examples of usual additives are stabilizers, antioxidants, lubricants, dyes, pigments, flame retardants, conductive fibres and reinforcing fibres.

Another aspect of the present invention is a cross-linked rubber composition that is obtained by cross-linking a rubber composition according to the invention.

In an embodiment, the cross-linked rubber composition has a hardness (measured by DIN-53505) ranging from 55° Sh A to 95° Sh A.

In an embodiment, the cross-linked rubber composition has a rebound value at 70° C. (as per ISO 4662) ranging from 54% to 82%.

In an embodiment, the cross-linked rubber composition has a tan delta value at 70° C. (as per DMA double shear 25° C. to 80° C. at 6% strain) ranging from 0.04 to 0.20.

The present invention also relates to a method of preparing a tyre, comprising the steps of:

providing a tyre assembly comprising a cross-linkable rubber composition according to the invention; and

cross-linking at least the cross-linkable rubber composition according to the invention in the tyre assembly.

The present invention also encompasses a tyre comprising at least one body compound, wherein the body compound comprises a cross-linked rubber composition according to the invention. The body compound may be selected from a cap ply, body ply, belt, apex (dual apex), run flat insert, sidewall, under tread (base) or a combination thereof.

The present invention also encompasses a body compound of a tyre, wherein the body compound is selected from a cap ply, body ply, belt, apex (dual apex), run flat insert, sidewall, under tread (base) or a combination thereof, wherein the body compound comprises a cross-linked rubber composition according to the invention.

In an embodiment of the body compound or the tyre, the body compound is a cap ply which should have a good adhesion with textile cord. The ratio in phr (parts by weight per 100 parts by weight of rubber) of the syndiotactic 1, 2-polybutadiene to the resin in a cap ply preferably is in the range of ≥2:1 to ≤7:1.

In an embodiment of the body compound or the tyre, the body compound is a body ply which should have a good adhesion with textile cord, and adhesion and property retention for tire durability. The ratio in phr (parts by weight per 100 parts by weight of rubber) of the syndiotactic 1, 2-polybutadiene to the resin in a body ply preferably is 4:1.

In an embodiment of the body compound or the tyre, the body compound is a belt which should have a good adhesion to brass coated steel cord. The ratio in phr (parts by weight per 100 parts by weight of rubber) of the syndiotactic 1, 2-polybutadiene to the resin in a belt is preferably in the range of ≥3:1 to ≤5:1.

In an embodiment of the body compound or the tyre, the body compound is an apex or a dual apex which is used as filler over the bead bundle to give structural stability. Due to higher apex stiffness, it can be used to reinforce rim region for better stiffness. IT is further used as dual apex concept or elastomer chipper. The ratio in phr (parts by weight per 100 parts by weight of rubber) of the syndiotactic 1, 2-polybutadiene to the resin in an apex or a dual apex is preferably in the range of ≥1:1 to ≤2:1.

In an embodiment of the body compound or the tyre, the body compound is a run flat insert which is used to reinforce the sidewall region. In case of sudden loss of air from tire it avoids disability and provide drivability to vehicle due to compound stiffness and dimension of insert. The ratio in phr (parts by weight per 100 parts by weight of rubber) of the syndiotactic 1, 2-polybutadiene to the resin in a run flat insert preferably is in the range of ≥3:1 to ≤5:1.

In an embodiment of the body compound or the tyre, the body compound is a sidewall which should have good environmental & flex property and abrasion & tear resistance. The ratio in phr (parts by weight per 100 parts by weight of rubber) of the syndiotactic 1, 2-polybutadiene to the resin in a side wall preferably is in the range of ≥1:1 to ≤2:1.

In an embodiment of the body compound or the tyre, the body compound is an under tread or a base tread which can be used as cushion layer to balance stiffness gradient between belt and tread. The ratio in phr (parts by weight per 100 parts by weight of rubber) of the syndiotactic 1, 2-polybutadiene to the resin in an under tread or a base tread is preferably in the range of ≥1:1 to ≤3:1.

The invention will be further described with reference to the following examples without wishing to be limited by them.

Methods:

Hardness Test: A hardness test was performed on a Zwick 3150 Shore A Hardness Tester according to DIN-53505 at 23° C. The hardness (in Shore A) for a test specimen was measured by making 5 determinations at different positions using a Durometer type A as described in the Hardness Shore A manual from Zwick. The determinations were at least 6.0 mm apart and at least 12 mm from any edge.

Tensile strength: Tensile strength analysis was performed for cured samples by Zwick Z005 apparatus with a speed of 500 mm/min speed. Samples were cured at 160° C. for 20 minutes and standard tensile specimens were cut from rubber sheet according to ISO 37 standard. Measuring force elongation properties via tensile method also determines modulus at various elongations i.e. 25%, 100%, 200% & 300%; which indicates (or correlates to) static stiffness and ultimate elongation at break.

Rebound: Rebound measurements were performed for cured samples on a Bareiss digi test II Rebound Resilience Tester at a temperature of 70° C. Samples were cured at 70° C. as round shape of 28 mm diameter and 12 mm thickness.

Dynamic mechanical properties by DMA: Dynamic mechanical analysis (DMA) analysis of rubber compounds was performed for cured samples by Metravib DMA+450 in double shear mode. Samples were cured at 170° C. for 10 minutes shaped as cylinders of 8 mm diameter and 2 mm thickness. DMA was performed by temperature sweep at constant frequency 10 Hz with 6% strain in a temperature range of 25° C. to 80° C.

General procedure for preparing cross-linked rubber compositions: cross-linkable rubber compositions were prepared as described in the examples and cross-linked. Materials mentioned in the tables were:

The NR rubber used was TSR20.

The butadiene rubber was Neodymium catalysed supplied by Arlenxo.

The syndiotactic 1, 2-polybutadiene was AT 400 syndiotactic 1,2-butadiene supplied by JSR Corporation.

The filler 1 was carbon black

The filler 2 was silica

The resin was C10 resin supplied by Kraton Corporation

In accordance with the preceding, cross-linkable rubber compositions were prepared from compounds as described in the tables below. Amounts are given in phr (parts by weight per 100 parts by weight of rubber). In a first step, all rubber components were added and mixed, followed by a second step wherein all additives were added and mixed and a last step wherein the curing package was added.

### EXAMPLE 1

The table below shows the composition C1 and C2 for cap ply in comparison to a reference composition Ref1 wherein the composition is free from plasticizing oil, tackifier resin, homogenizing resin.

TABLE 1

| Components | Ref1 | C1 | C2 |
|---|---|---|---|
| NR TSR20 | 75 | 75 | 75 |
| BR | 25 | — | 15 |
| AT400 | — | 25 | 10 |
| Processing oil RAE | 8 | — | — |
| CI resin - Novares C10 | — | 4 | 4 |
| Filler 1 | 55 | 35 | 35 |
| Filler 2 | — | 5 | 5 |
| Tackifier & Homoginizer | — | — | — |
| resins | | | |

The following table shows the results obtained from the cured compositions of table 1:

TABLE 2

| Result | | Ref1 | C1 | C2 |
|---|---|---|---|---|
| Hardness (median) | °Sh A | 55.30 | 69.50 | 57.70 |
| Elongation at break | % | 505.55 | 555.23 | 554.60 |
| M300% | MPa | 11.12 | 11.25 | 10.20 |
| Rebound (70° C.) | % | 71.20 | 73.00 | 74.50 |
| Tan (70° C.) | | 0.1 | 0.07 | 0.07 |

The results show an increase in the hardness from 55.30 to 69.50 and 57.70 in compositions C₁ and C₂ respectively. The increase in hardness is a well-known indicator of better stiffness in the tyre industry.

The results further show an increase in rebound at 70 degrees from 71.20 to 73.00 and 74.50 in compositions C₁ and C₂ respectively and a decrease in tan S at 70 degrees from 0.1 to 0.07 in both compositions C1 and C2. The increase in rebound and decrease in tan δ are well known indicators of improvement in hysteresis in the tyre industry.

### Example 2

The table below shows the composition C₃ for body ply in comparison to a reference composition Ref₂ wherein the composition is free from plasticizing oil, tackifier resin, homogenizing resin.

TABLE 3

| Components | Ref₂ | C₃ |
|---|---|---|
| NR TSR20 | 80 | 80 |
| BR | 20 | — |
| AT400 | — | 20 |
| Processing oil RAE | 6 | — |
| CI resin - Novares C10 | — | 5 |
| Filler 1 | 55 | 40 |
| Tackifier & Homoginizer | 1.5 | — |
| resins | | |

The following table shows the results obtained from the cured compositions of table 3:

TABLE 4

| Result | | Ref₂ | C₃ |
|---|---|---|---|
| Hardness (median) | °Sh A | 56.90 | 67.60 |
| Elongation at break | % | 479.31 | 449.96 |
| M300% | MPa | 12.07 | 12.99 |
| Rebound (70° C.) | % | 69.70 | 75.70 |
| Tan (70° C.) | | 0.09 | 0.06 |

The results show an increase in the hardness from 56.90 to 67.60 in composition C₃. The increase in hardness is a well-known indicator of better stiffness in the tyre industry.

The results further show an increase in rebound at 70 degrees from 69.70 to 75.70 in composition C₃ and a decrease in tan δ at 70 degrees from 0.09 to 0.06 in composition C₃. The increase in rebound and decrease in tan δ are well known indicators of improvement in hysteresis in the tyre industry.

### Example 3

The table below shows the compositions C₄ and C₅ respectively for belt in comparison to a reference composition Ref₃ wherein the composition is free from plasticizing oil, tackifier resin, homogenizing resin.

TABLE 5

| Components | Ref₃ | C₄ | C₅ |
|---|---|---|---|
| NR TSR20 | 100 | 90 | 85 |
| AT400 | — | 10 | 15 |
| Processing oil RAE | 3 | — | — |
| CI resin - Novares C10 | — | 3 | 3 |
| Filler 1 | 48 | 40 | 35 |

The following table shows the results obtained from the cured compositions of table 5:

TABLE 6

| Result | | Ref₃ | C₄ | C₅ |
|---|---|---|---|---|
| Hardness (median) | °Sh A | 73.70 | 72.00 | 73.60 |
| Elongation at break | % | 375.05 | 347.19 | 394.85 |
| M300% | MPa | 18.71 | 16.67 | 16.01 |
| Rebound (70° C.) | % | 63.50 | 67.60 | 69.70 |
| Tan (70° C.) | | 0.14 | 0.09 | 0.08 |

The results show an increase in rebound at 70 degrees from 63.50 to 67.60 and 69.70 in compositions C₄ and C₅ respectively and a decrease in tan δ at 70 degrees from 0.14 to 0.09 and 0.08 in compositions C₄ and C₅ respectively. The increase in rebound and decrease in tan δ are well known indicators of improvement in hysteresis in the tyre industry.

It can also be seen that the hardness of the rubber compositions C₄ and C₅ with respect to Ref₃ is on par.

### Example 4

The table below shows the compositions C₆ and C₇ for apex in comparison to a reference composition Ref₄ wherein the composition is free from plasticizing oil, tackifier resin, homogenizing resin.

TABLE 7

| Components | Ref₄ | C₆ | C₇ |
|---|---|---|---|
| NR TSR20 | 70 | 70 | 70 |
| BR | 30 | 20 | 15 |
| AT400 | — | 10 | 15 |
| Processing oil RAE | 7 | — | — |
| CI resin - Novares C10 | — | 10 | 10 |
| Filler 1 | 55 | 50 | 50 |
| Tackifier & Homoginizer | 6 | — | — |
| resins | | | |

The following table shows the results obtained from the cured compositions of table 7:

TABLE 8

| Result | | Ref₄ | C₆ | C₇ |
|---|---|---|---|---|
| Hardness (median) | °Sh A | 85.10 | 89.50 | 92.10 |
| Elongation at break | % | 367.59 | 353.04 | 362.01 |
| M300% | MPa | 11.74 | 13.27 | 13.02 |
| Rebound (70° C.) | % | 51.80 | 54.60 | 57.40 |
| Tan (70° C.) | | 0.20 | 0.17 | 0.14 |

The results show an increase in the hardness from 85.10 to 89.50 and 92.10 in compositions C₆ and C₇ respectively. The increase in hardness is a well-known indicator of better stiffness in the tyre industry.

The results further show an increase in rebound at 70 degrees from 51.80 to 54.60 and 57.40 in compositions C₆ and C₇ respectively and a decrease in tan δ at 70 degrees from 0.20 to 0.17 and 0.14 in compositions C₆ and C₇ respectively. The increase in rebound and decrease in tan δ are well known indicators of improvement in hysteresis in the tyre industry.

### Example 5

The table below shows the compositions C₅ and C₉ for run flat insert in comparison to a reference composition Ref₅ wherein the the composition is free from plasticizing oil, tackifier resin, homogenizing resin.

TABLE 9

| Components | Ref₅ | C₈ | C₉ |
|---|---|---|---|
| NR TSR20 | 30 | 30 | 30 |
| BR | 70 | 60 | 65 |
| AT400 | | 10 | 15 |
| Processing oil RAE | 2 | — | — |
| CI resin - Novares C10 | — | 3 | 3 |
| Filler 1 | 62 | 50 | 50 |
| Tackifier & Homoginizer | 6.4 | — | — |
| resins | | | |

The following table shows the results obtained from the cured compositions of table 9:

TABLE 10

| Result | | Ref₅ | C₈ | C₉ |
|---|---|---|---|---|
| Hardness (median) | °Sh A | 72.00 | 71.40 | 73.10 |
| Elongation at break | % | 114.84 | 110.15 | 111.77 |
| Rebound (70° C.) | % | 80.60 | 81.90 | 79.70 |
| Tan (70° C.) | | 0.16 | 0.04 | 0.10 |

The results show an increase in the hardness from 72.00 to 71.40 and 73.10 in compositions C₅ and C₉ respectively. The increase in hardness is a well-known indicator of better stiffness in the tyre industry.

The results further show an increase in rebound at 70 degrees from 80.60 to 81.90 and 79.70 in compositions C₈ and C₉ respectively and a decrease in tan δ at 70 degrees from 0.16 to 0.04 and 0.10 in compositions C₈ and C₉ respectively. The increase in rebound and decrease in tan δ are well known indicators of improvement in hysteresis in the tyre industry.

### Example 6

The table below shows the compositions C₁₀ and C₁₁ respectively for side wall in comparison to a reference composition Ref₁ wherein the composition is free from plasticizing oil, tackifier resin, homogenizing resin.

TABLE 11

| Components | Ref₆ | C₁₀ | C₁₁ |
|---|---|---|---|
| NR TSR20 | 35 | 35 | 35 |
| BR | 45 | 35 | 35 |
| SBR | 20 | 20 | 20 |
| AT400 | | 10 | 10 |
| Processing oil RAE | 7 | — | — |
| CI resin - Novares C10 | — | 7 | 7 |
| Filler 1 | 42 | 35 | — |
| Filler 2 | — | — | 35 |
| Tackifier & Homoginizer | 3.5 | — | — |
| resins | | | |

The following table shows the results obtained from the cured compositions of table 11:

TABLE 12

| Result | | Ref₆ | C₁₀ | C₁₁ |
|---|---|---|---|---|
| Hardness (median) | °Sh A | 55.90 | 58.30 | 55.30 |
| Elongation at break | % | 414.37 | 429.03 | 493.54 |
| M300% | MPa | 9.82 | 9.36 | 7.09 |
| Rebound (70° C.) | % | 66.10 | 69.70 | 73.30 |
| Tan (70° C.) | | 0.13 | 0.09 | 0.07 |

The results show an increase in the hardness from 55.90 to 58.30 and 55.30 in compositions C₁₀ and C₁₁ respectively. The increase in hardness is a well-known indicator of better stiffness in the tyre industry.

The results further show an increase in rebound at 70 degrees from 66.10 to 69.70 and 73.30 in compositions C₁₀ and C₁₁ respectively and a decrease in tan δ at 70 degrees from 0.13 to 0.09 and 0.07 in compositions C₁₀ and C₁₁ respectively. The increase in rebound and decrease in tan δ are well known indicators of improvement in hysteresis in the tyre industry.

### Example 7

The table below shows the compositions C₁₂ and C₁₃ for under tread in comparison to a reference composition Ref₇ wherein the composition is free from plasticizing oil, tackifier resin, homogenizing resin.

TABLE 13

| Components | Ref₇ | C₁₂ | C₁₃ |
|---|---|---|---|
| NR TSR20 | 100 | 90 | 85 |
| AT400 | — | 10 | 15 |
| CI resin - Novares C10 | — | 6 | 6 |
| Filler 1 | 44 | 40 | 35 |
| Tackifier & Homoginizer | 6.5 | — | — |
| resins | | | |

The following table shows the results obtained from the cured compositions of table 13:

TABLE 14

| Result | | Ref₇ | C₁₂ | C₁₃ |
|---|---|---|---|---|
| Hardness (median) | °Sh A | 59.20 | 62.80 | 64.70 |
| Elongation at break | % | 415.79 | 455.21 | 481.95 |
| M300% | MPa | 15.92 | 13.58 | 12.13 |
| Rebound (70° C.) | % | 70.30 | 71.50 | 72.70 |
| Tan (70° C.) | | 0.09 | 0.08 | 0.07 |

The results show an increase in the hardness from 59.20 to 62.80 and 64.70 in compositions C₁₂ and C₁₃ respectively. The increase in hardness is a well-known indicator of better stiffness in the tyre industry.

The results further show an increase in rebound at 70 degrees from 70.30 to 71.50 and 72.70 in compositions C₁₂ and C₁₃ respectively and a decrease in tan δ at 70 degrees from 0.09 to 0.08 and 0.07 in compositions C₁₂ and C₁₃ respectively. The increase in rebound and decrease in tan δ are well known indicators of improvement in hysteresis in the tyre industry.

Such cross-linked rubber compositions are particularly usable for manufacturing tyre body compounds.

1. A cross-linkable rubber composition for body compounds of a tyre, the cross-linkable rubber composition comprising, based upon parts by weight per 100 parts by weight rubber (phr):
≥30 to ≤590 phr of a natural rubber or isoprene rubber or combination thereof,
≥10 to ≤525 phr of a syndiotactic 1, 2-polybutadiene,
≥3 to ≤510 phr of a resin, and
a filler,
wherein,
the ratio in parts by weight per 100 parts by weight of the syndiotactic 1,2-polybutadiene to the resin is in the range of ≥1:1 to ≤7:1.

2. The rubber composition according to claim 1, wherein the resin is selected from the class of hydrocarbon thermoplastic resins with melting point above −25° C. such as terpene based resins, alpha methyl styrene, styrene functionalized resins, coumarone indene based resins, C5 resins, C9 resins, or a combination thereof.

3. The rubber composition according to claim 1, wherein the resin is a C10 resin.

4. The rubber composition according to claim 1, wherein the filler is selected from silica, carbon black or combination thereof.

5. The rubber composition according to claim 1 wherein the filler is present in an amount of ≥30 phr to ≤560 phr.

6. The rubber composition according to claim 1, wherein the composition further comprises a second rubber selected from butadiene rubber, styrene butadiene rubber, solution polymerized styrene butadiene rubber or combination thereof.

7. The rubber composition according to claim 1, wherein the second rubber is present in an amount of ≥15 phr to ≤560 phr.

8. The rubber composition according to claim 1, wherein the composition is free from plasticizing oil, tackifier resin, homogenizing resin or a combination thereof.

9. A cross-linked rubber composition, obtained by cross-linking a rubber composition according to claim 1.

10. The cross-linked rubber composition according to claim 9, wherein the composition has hardness (measured by DIN-53505) ranging from 55° Sh A to 95° Sh A.

11. The cross-linked rubber composition according to claim 9 with a rebound value at 70° C. (as per ISO 4662) ranging from ≥54% to ≤82%.

12. The cross-linked rubber composition according to claim 9 with a tan delta value at 70° C. (as per DMA double shear 25° C. to 80° C. at 6% strain) ranging from ≥0.04 to ≤0.20.

13. A method of preparing a tyre, comprising the steps of:
providing a tyre assembly comprising a cross-linkable rubber composition according to claim 1; and
cross-linking at least the cross-linkable rubber composition in the tyre assembly.

14. A tyre comprising at least one body compound, wherein the body compound comprises a cross-linked rubber composition according to claim 9.

15. A body compound of a tyre, wherein the body compound is selected from a cap ply, body ply, belt, apex (dual apex), run flat insert, sidewall, under tread (base) or a combination thereof, wherein the body compound comprises a cross-linked rubber composition according to claim 9.
